(19) United States
(12) Patent Application Publication
(10) Pub. No.: US 2026/0339030 A1
(43) Pub. Date: Oct. 29, 2026

(54) NUMERICAL APERTURE CLADDING LIGHT STRIPPER WITH OVER-TAPERING

(71) Applicant: Lumentum Operations LLC, San Jose, CA (US)

(72) Inventors: Gongwen ZHU, San Jose, CA (US); Richard D. FAULHABER, San Carlos, CA (US); Jeff GREGG, San Jose, CA (US)

(21) Appl. No.: 19/282,358

(22) Filed: Jul. 28, 2025

Related U.S. Application Data
(60) Provisional application No. 63/796,702, filed on Apr. 29, 2025.

(51) Int. Cl. G02B 6/28

(52) U.S. Cl. CPC G02B 6/2821

(57) ABSTRACT

In some implementations a cladding light stripper may include one or more input fibers that have an effective input diameter, an output fiber that has an output diameter, and a light removal section. The light removal section may include a down-tapered section and an up-tapered section. The down-tapered section may taper the one or more input fibers from the effective input diameter down to a tapered diameter. The up-tapered section, connected to the down-tapered section, may taper the output fiber from the tapered diameter up to the output diameter. In some examples, an up-taper ratio of the up-tapered section and a numerical aperture (NA) of the light removal section may define an NA threshold for cladding light that can propagate through the output fiber.

### CROSS-REFERENCE TO RELATED APPLICATION

This patent application claims priority to U.S. Patent Application No. 63/769,702, filed on Apr. 29, 2025, and entitled “NUMERICAL APERTURE CLADDING LIGHT STRIPPER WITH OVER-TAPERING.” The disclosure of the prior Application is considered part of and is incorporated by reference into this patent application.

### TECHNICAL FIELD

The present disclosure relates generally to a cladding light stripper and to light removal via over-tapering.

### BACKGROUND

An optical fiber can include a core, which carries light, and a cladding, which surrounds the core and is configured to confine the light within the core. A cladding light stripper is used to remove or extract light that is in the cladding of the optical fiber.

### SUMMARY

In some implementations, a cladding light stripper may include one or more input fibers that have an effective input diameter; an output fiber that has an output diameter; and a light removal section, where the light removal section may include a down-tapered section that tapers the one or more input fibers from the effective input diameter down to a tapered diameter; and an up-tapered section, connected to the down-tapered section, that tapers the output fiber from the tapered diameter up to the output diameter, wherein an up-taper ratio of the up-tapered section and a numerical aperture (NA) of the light removal section define an NA threshold for cladding light that can propagate through the output fiber.

In some implementations, a cladding light stripper may include an input fiber that has an input diameter; an output fiber that has an output diameter; and a light removal section, where the light removal section may include a down-tapered section that tapers the input fiber from the input diameter down to a tapered diameter; and an up-tapered section, connected to the down-tapered section, that tapers the output fiber from the tapered diameter up to the output diameter, wherein an up-taper ratio of the up-tapered section and an NA of the light removal section define an NA threshold for cladding light that can propagate through the output fiber.

In some implementations, an optical fiber system incorporating a cladding light stripper may include a plurality of input fibers that have an effective input diameter; an output fiber that has an output diameter; a light removal section that includes a down-tapered section that tapers the plurality of input fibers from the effective input diameter down to a tapered diameter and an up-tapered section, connected to the down-tapered section, that tapers the output fiber from the tapered diameter up to the output diameter, where an up-taper ratio of the up-tapered section and an NA of the light removal section define an NA threshold for cladding light that can propagate through the output fiber; a light blocker positioned around a portion of the up-tapered section that is configured to block a portion of the cladding light, that escapes from the light removal section, from entering the output fiber; and a metal housing that encloses the cladding light stripper and is configured to absorb heat from the portion of the cladding light that escapes from the light removal section.

### BRIEF DESCRIPTION OF THE DRAWINGS

FIG. 1 shows a side-view of a fiber combiner.

FIG. 2 shows a side-view of a cladding light stripper, according to one or more implementations.

FIG. 3 shows light stripping at a cladding light stripper according to one or implementations.

FIG. 4 shows a cross-sectional view of a housing that encloses a cladding light stripper according to one or implementations.

FIG. 5 illustrates an example laser system according to one or more implementations.

### DETAILED DESCRIPTION

The following detailed description of example implementations refers to the accompanying drawings. The same reference numbers in different drawings may identify the same or similar elements.

In some cases, such as for high-power (e.g., kilowatt class, or greater) applications, a laser can include an optical fiber that includes a polymeric coating (e.g., that circumferentially surrounds a cladding of the optical fiber). The polymeric coating can have a low refractive index to guide light (e.g., cladding light) within the cladding of the optical fiber (e.g., in addition to core light that propagates within a core of the optical fiber). Because of a low melting point, the polymeric coating may be considered to be a weak point in the construction and operation of high-power lasers. For example, a packing process to form a high-power laser can cause an optical fiber to be manipulated (e.g., bent or twisted) such that high-power light that propagates via the optical fiber then leaks out of a cladding of the optical fiber in an uncontrolled manner. This leaked high-power light then overheats the polymeric coating of the optical fiber, which degrades a performance of the optical fiber (and the high-power laser that includes the optical fiber), and leads to failure of the optical fiber (and the high-power laser). Consequently, there is a need to mitigate and/or manage leaked cladding light from an optical fiber, especially for high-power applications.

High numerical aperture (NA) cladding light is a common issue in cladding-pumped high power fiber lasers, where the NA cladding light can reduce the performance and reliability of the laser systems. NA cladding light is light that propagates within the cladding layer of an optical fiber, characterized by an NA that exceeds the guiding capability of the core of the optical fiber, potentially leading to inefficiencies and heating issues in fiber laser systems. As used herein, a component (or a material of the component) may be described as “having an NA” or “with an NA.” This refers to a property of an interface between the component and another component (e.g., comprising another material) (or air), and is based on respective refractive indices of the component and the other component (or air). The NA of the component characterizes a range of angles over which the interface reflects or transmits light. In a specific example, for fiber optics, an NA of an optical fiber describes a range of angles within which light incident within the optical fiber is transmitted along the optical fiber (e.g., within the optical fiber), instead of leaking out of the optical fiber. When a component is described as having an X NA, the maximum NA that the component can support is X (e.g., to allow total internal reflection within the component). Additionally, as used herein, light (e.g., cladding light) may be described as “having an NA,” which characterizes a range of angles at which the light propagates (e.g., through an optical fiber). When light is described as having a Y NA, the maximum NA of the light is Y.

In some double-clad or triple-clad fibers, the outer cladding may be made from a low index polymer coating, such as silicone or other materials, which serves as an additional layer to guide light. This outer cladding typically may have an NA around 0.48 (although the NA can vary, with values that range from 0.46 to 0.55, or other ranges of NA). When the NA of the light exceeds the NA of the outer cladding, the light can enter into the outer cladding, leading to excessive heating or even fiber burns. This is particularly concerning because high power fiber lasers are designed to operate at elevated power levels, and any inefficiencies or damage can severely impact their performance. The problem may be further exacerbated by potential defects in the fiber system, such as those arising from fiber splicing or bending. These imperfections can inadvertently generate light with an NA that exceeds the NA of the optical fiber cladding, further increasing the risk of excessive heating or burns in the polymer cladding or the recoated sections of the fiber. Even in cases where the NA of light is below the NA of the optical fiber cladding, evanescent waves may still partially travel within the polymer cladding, causing the cladding to heat up. The higher the NA, the more pronounced this heating effect becomes, posing a threat to the integrity of the optical fiber.

Some implementations described herein include laser systems that implement one or more cladding light strippers with an over-tapering design. For instance, the cladding light stripper may include a junction where one or more input fibers are spliced and connected to an output fiber. In accordance with the over-tapering design, the diameter of the one or more input fibers may be tapered down to a smaller diameter during a down-tapered section of the one or more input fibers, where this smaller diameter may serve as an over-tapered diameter. Additionally, this over-tapered diameter may be smaller than the diameter of the output fiber, such that an output fiber includes an up-tapered section that is spliced with the down-tapered section, where in the up-tapered section the fiber diameter tapers up to the diameter of the output fiber. In some implementations, the down-tapered section may be associated with a taper ratio (TR) indicating the factor by which the diameter of the one or more input fibers are over-tapered. Additionally, the value of the TR may define an NA threshold, where light from the one or more input fibers with an NA above the NA threshold may escape from or permeate out of the cladding light stripper during the down-tapered section. Accordingly, the TR of the down-tapered section and/or the TR of the up-tapered section may be configured to define the NA threshold to remove NA cladding light before entering the output fiber to reduce a probability of fiber burns and improve reliability of the laser system.

In this way, some implementations allow for selective stripping of a specific range of NAs of unwanted cladding light from the optical fiber. When used in a high-power application, this reduces a likelihood that high-power cladding light leaks (e.g., in a region associated with a splice point or other point where high NA cladding light is likely to be present) and overheats the coating of the output fiber. Therefore, implementation of an over-tapered light stripper improves a performance of the optical output fiber, and reduces a likelihood of failure of the output fiber. Further, this thereby improves a performance of a laser system that includes the cladding light stripper and the output fiber and reduces a likelihood of failure of the laser system.

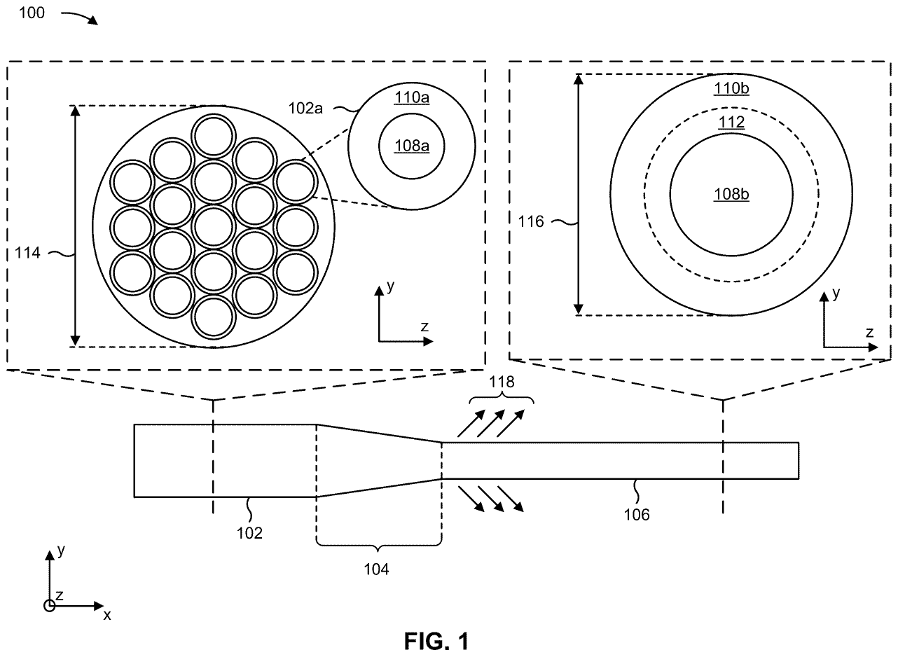

FIG. 1 shows a side-view of a fiber combiner 100. The fiber combiner 100 includes one or more input fibers 102, a tapered section 104, and an output fiber 106.

The one or more input fibers 102 (e.g., denoted as N-fibers where “N” refers to the number of individual input fibers 102), may comprise multiple optical fibers that are grouped together to deliver or receive optical signals. An optical fiber may be a flexible, transparent strand (e.g., made of glass or plastic, or another material) designed to transmit light from one end to the other. This transmission occurs through the principle of total internal reflection. The principle of total internal reflection occurs when light traveling within a medium of higher refractive index (such as the core of an optical fiber) strikes a boundary with a medium of lower refractive index (such as the cladding) at an angle greater than a critical angle. At this point, all of the light is reflected back into the higher-index medium rather than passing through the boundary, allowing efficient confinement and guidance of light within the optical fiber. Optical fibers may be used in telecommunications, medical instruments, and industrial applications due to their ability to carry large amounts of data or power in the form of light. For instance, the one or more input fibers 102 can be configured to transmit a high-power optical beam (e.g., such as more than 200 watts (W), more than 1 kilowatt (kW), or even more than 10 kW) which may be used for material processing and other industrial purposes. In these settings, high-power light beams may be used for cutting, welding, and/or surface treatment of materials, where precise and robust energy delivery is essential.

There may be multiple input fibers 102 in a system for several reasons. For example, using multiple input fibers 102 enables the distribution of the optical power among several channels, reducing the risk of damage to individual fibers and increasing the overall system reliability. Additionally, or alternatively, multiple input fibers 102 may allow for the combination or multiplexing of different light sources, wavelengths, or beam profiles, providing greater flexibility and control over the delivered optical beam. Additionally, or alternatively, in high-power applications, spreading the power across several fibers helps to manage thermal loads and avoid nonlinear optical effects that could degrade system performance. This multi-fiber approach ensures safe, efficient, and scalable transmission of high-power optical energy for demanding industrial tasks. While FIG. 1 shows the set of input fibers 102 including 19 input fibers 102, in other implementations, the set of input fibers 102 may include any number of input fibers 102 (e.g., one input fiber or any other number).

The output fiber 106 may be a single optical fiber that is spliced to the set of input fibers 102, serving as the conduit through which the combined optical power from the multiple inputs is delivered to the target application. The splicing process involves physically joining the ends of the input fibers 102 to the end of the output fiber 106 in such a way that the optical signals from all input fibers 102 are efficiently coupled into a core of the output fiber 106. This can be accomplished using techniques such as thermal fusion splicing, where heat is applied to melt and fuse the glass ends together, and/or by mechanical splicing, where the input fibers 102 and the output fiber 106 are aligned and held in place by a fixture. In some implementations, the ends of the input fibers 102 are arranged and aligned with the core 108 of the output fiber 106 to reduce optical losses and ensure that the majority of the light from each input fiber 102 is transferred into the output fiber 106.

Both the input fibers 102 and the output fiber 106 may include a core 108, which may be the central region of the fiber responsible for guiding the majority of the optical signal. The core 108 may comprise a high-purity glass or plastic with a refractive index that is higher than the surrounding layers, allowing the core 108 to confine light by total internal reflection. For example, an input fiber may have a core 108a, while the output fiber 106 may have a core 108b. These cores 108 may be engineered to optimize optical transmission, ensuring that light is efficiently guided along the length of the fiber with minimal loss.

Surrounding the core 108, optical fibers may include one or more cladding layers. The cladding is a layer of material with a lower refractive index than the core 108, which serves to further confine the light within the core 108 by reflecting stray light back into the core 108, thereby enhancing the efficiency and performance of the fibers. Specifically, an outer cladding layer 110 may be the outermost cladding that encases the core 108 (and any inner cladding layers), providing structural integrity and additional optical isolation. The outer cladding layer 110 may comprise glass, such as silica, or a polymer material chosen for its durability and compatibility with the core 108. For example, an input fiber 102a from the multiple input fibers 102 may have an outer cladding layer 110a, and the output fiber 106 may have an outer cladding layer 110b. These outer cladding layers 110 help to maintain signal quality, protect the core 108 from physical damage, and prevent loss of optical power during transmission.

In addition to the core 108 and outer cladding layer 110, the optical fibers may also include one or more interior cladding layers 112 (such as double clad or triple clad fibers). These interior cladding layers 112 may be concentric regions that surround the core 108 and are positioned between the core 108 and the outer cladding layer 110. The one or more interior cladding layers 112 may be used to enable advanced optical functions, such as supporting higher power transmission or enabling the collection and guidance of pump light in fiber lasers and amplifiers. In some implementations, the interior cladding layers 112 may comprise glass or polymer materials with specifically engineered refractive indices. For instance, a refractive index of each interior cladding layer 114 may be lower than that of the core 108 but may be higher or lower than that of the outer cladding layer 110, depending on the design of the fiber. For example, in a double clad fiber, the core 108 (with the highest refractive index) is surrounded by the first interior cladding layer (with a lower refractive index than the core 108), and then by an outer cladding layer 110 (with the lowest refractive index). This arrangement allows the core 108 to guide the primary optical signal, while the interior cladding(s) can guide pump light or additional modes, enhancing the fiber functionality for high-power or specialized optical applications.

To facilitate this transition from the input fibers 102 to the output fiber 106, a tapered section 104 may be introduced at the junction between the input fibers 102 and the output fiber 106. In this arrangement, the bundle of multiple input fibers 102 initially has an effective input diameter 114 (e.g., D_{eff}) that is greater than an output diameter 116 (e.g., Dₒᵤₜₚᵤₜ) of the output fiber 106. For an N-fiber input fiber bundle (Nᵢₙₚᵤₜₛ), where each input fiber has a same cladding diameter (Dᵢₙₚᵤₜ), the effective input diameter 114 (D_{eff}) for the input fiber bundle may be in accordance with Equation 1:

D_{eff}=\sqrt{Nᵢₙₚᵤₜₛ}(Dᵢₙₚᵤₜ) (1)

The tapered section 104 serves to gradually reduce this effective input diameter 114, smoothly guiding the combined optical signals from the larger bundle into the smaller core 108 of the output fiber 106. The tapered section 104 may be formed by heating and stretching the input fibers 102 so that the input fibers 102 narrow down over a certain length, allowing for an adiabatic transition where the optical modes adapt from the multiple input fibers 102 into the single output fiber 106.

Additionally, a taper ratio (TR) of the tapered section 104 may be based on the effective input diameter 114 (D_{eff}) and the cladding diameter of the output fiber 106 (Dₒᵤₜₚᵤₜ), in accordance with Equation 2:

$$TR = \frac{{D}_{eff}}{{D}_{output}} = \sqrt{{N}_{inputs}} ( \frac{{D}_{input}}{{D}_{output}} ) \qquad ( 2 )$$

In some examples, the input fibers 102 and the output fiber 106 may be associated with or have an NA value. The NA of the input fibers 102 and output fiber 106 is an optical property that determines how effectively each fiber can capture, confine, and transmit light. NA is related to the difference in refractive indices between the core 108 of the fiber and the one or more adjacent cladding layers, which defines the range of incident angles at which light can enter the fiber and still be guided along the length of the fiber. When referring to the “maximum angle” in the context of NA and optical fibers, the angle is measured relative to the fiber axis (e.g., the central axis or longitudinal axis of the fiber). This axis runs along the length of the fiber, and the maximum angle describes how steeply light rays can enter or propagate within the fiber core (relative to this axis) while still being totally internally reflected and guided through the fiber. If the angle between the light ray and the fiber axis exceeds this maximum (determined by the NA), the light will not be confined by total internal reflection and may escape from the core or cladding. In other words, the NA characterizes the acceptance cone of the fiber (e.g., the larger the NA, the wider the range of angles from which light can successfully enter and propagate through the fiber without escaping through the cladding layer). For both input fibers 102 and output fiber 106, the NA is therefore defined by the interface between the core 108 and the surrounding cladding, or between the fiber and the external environment (such as air). This means that, depending on the specific refractive indices of the materials used in the core 108 and cladding, different fibers can be engineered to have higher or lower NAs. A higher NA may be useful for collecting light from sources that emit over a wide range of angles, or for transmitting high-power beams. Conversely, a lower NA results in a narrower acceptance angle, which can be beneficial for reducing modal dispersion and improving signal fidelity in telecommunications applications. Thus, the choice of NA for the input fibers 102 and the output fiber 106 may be matched to the characteristics of the optical system, taking into account factors such as alignment tolerances, power handling, and the intended application, whether it is industrial material processing or precision optical communications.

Light propagating through the input fibers 102 can take several paths, such as through the core 108 and also through the cladding (e.g., a phenomenon referred to as “cladding light”). Cladding light is optical energy that travels within the cladding layers of the fiber, rather than being strictly confined to the core 108. Cladding light may occur in double-clad or multi-clad fibers, where the cladding is intentionally designed to guide light, such as pump light in fiber lasers or amplifiers. Cladding light may be less confined than core-guided light, and can traverse longer paths within the fiber, interacting with the core 108 or being absorbed elsewhere as part of the fiber function. Similar to core-guided light, cladding light can also be characterized by an NA value. The NA associated with cladding light defines the range of angles at which the light can propagate within the cladding without escaping, based on the refractive indices of the cladding layer and the surrounding material. When light is described as having a particular NA (e.g., a maximum NA of Y) it means that the light traveling through the cladding does so over a range of angles, but none exceeding the angle corresponding to an NA of Y. In other words, the cladding light may traverse the input fibers 102 across a spectrum of NAs, up to and including a maximum NA of Y.

Additionally, a relationship between the NA of the light within the input fibers 102 (NA_{in_light}) and an NA of light within the output fiber 106 (NA_{out_light}) may be based on the value of the taper ratio (TR) in accordance with Equation 3:

NA_{out_light}=TR(NA_{in_light}) (3)

As described by Equation 3, when the input fibers 102 are tapered down to match the output diameter 116 of the output fiber 106, the NA of the light emerging from the input fibers 102 increases in proportion to the taper ratio. This occurs because tapering the fibers causes the cross-sectional area through which the light propagates to decrease, effectively compressing the optical modes. As a result, the angles at which the light rays travel within the fiber become steeper relative to the axis of the fiber. Because NA is a measure of the maximum angle at which light can be guided within the fiber, reducing the fiber diameter by tapering increases the range of angles, and thus the NA, by a factor equal to the taper ratio.

In the context of FIG. 1, Equations 1 through 3 may be used to describe example values in which a resulting NA of light within the output fiber 106 (NA_{out_light}) may result in a reduction in power handling capability. As shown in FIG. 1, there are 19 input fibers 102 (e.g., Nᵢₙₚᵤₜₛ=19), the cladding diameter for each input fiber is 220 micrometers (μm) (e.g., Dᵢₙₚᵤₜ=220 μm), the output fiber 106 has a cladding diameter of 400 μm (e.g., Dₒᵤₜₚᵤₜ=400 μm), and the NA of the outer cladding layer 110b of the output fiber 106 is 0.48. Accordingly, the taper ratio (TR) for the tapered section 104 may be approximately 2.397. Additionally, in some implementations of laser diodes (such as high-power laser diodes), the NA of the input light may be 0.22 or higher (e.g., NA_{in_light}>0.22). In the first example, if a portion of the input light as an NA of 0.22 (e.g., NA_{in_light}=0.22) the NA of light in the output fiber 106 may be 0.527 (e.g., NA_{out_light}>0.527), which is greater than the NA of the outer cladding layer 110b of the output fiber 106 (e.g., 0.48). In FIG. 1, because 0.527>0.48, a portion of the light in the output fiber 106 may leak through the outer cladding layer 110 of the output fiber 106 (e.g., leaked light 118), causing heating and reducing the power handling capability.

This leaked light 118 can lead to one or more problems. For example, when high-power light escapes the fiber, the leaked light 118 can deposit energy into the coating of the output fiber 106 or surrounding materials, causing localized heating. Over time, this heating can damage the output fiber 106, resulting in fiber burns, melting, and/or failure of the fiber structure. In high-power applications, such as industrial laser delivery systems, this damage to the output fiber 106 reduces the efficiency of power transmission and may increase safety risks, including the potential for fire or damage to nearby equipment. Additionally, the leaked light 118 can degrade the overall optical performance of the system. The escaping leaked light 118 represents a loss of transmitted power, reducing the effectiveness of the output fiber 106 in delivering light. Moreover, the uncontrolled emission of high-intensity light from the output fiber 106 can create stray beams or scattered light, which may cause optical noise, interfere with surrounding instruments, and/or present hazards to operators.

FIG. 1 is provided as an example. Other examples may differ from what is described with regard to FIG. 1.

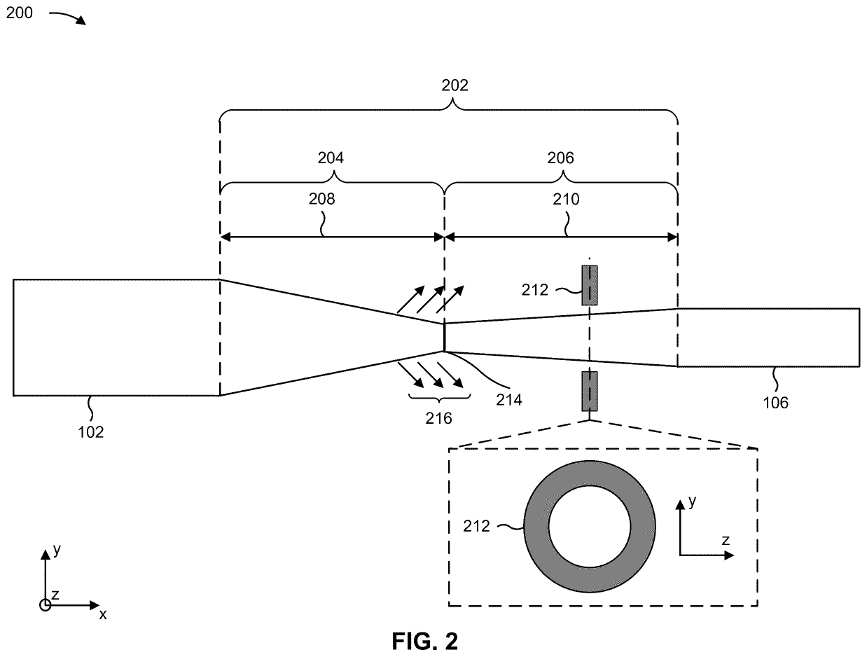

FIG. 2 shows a side-view of a cladding light stripper 200, according to one or more implementations. In some aspects, the cladding light stripper 200 may implement one or more aspects of the fiber combiner 100. For example, as shown in FIG. 2, the cladding light stripper 200 includes the one or more input fibers 102 that have an effective input diameter 114 and that are spliced to the output fiber 106 with the output diameter 116.

Additionally, the cladding light stripper 200 includes a light removal section 202. For example, the light removal section 202 may include a down-tapered section 204 and an up-tapered section 206. As shown in FIG. 2, the down-tapered section 204 tapers the one or more input fibers 102 from the effective input diameter 114 down to a tapered diameter at a junction 214, where the tapered diameter is less than the effective input diameter 114. Additionally, the up-tapered section 206, connected to the down-tapered section 204 at the junction 214, tapers the output fiber 106 from the tapered diameter up to the output diameter 116, where the tapered diameter is less than the output diameter 116. In other words, the light removal section 202 includes a junction 214 at which an end of the down-tapered section 204 connects to a start of the up-tapered section 206, where the one or more input fibers 102 are spliced to the output fiber 106 at the junction 214.

In some implementations, the tapered diameter may less than the output diameter 116, and the output diameter 116 may be less than or equal to the effective input diameter 114. As described herein, the input fiber bundle may include any number of input fibers 102. For instance, in implementations where the set of input fibers 102 includes a single input fiber (e.g., input fiber 102a), the effective input diameter 114 becomes the cladding diameter of the single input fiber.

According to the techniques described herein, the down-tapered section 204 may be over-tapered (e.g., the taper ratio is increased) such that an end portion of the down-tapered section 204 at the junction 214 is less than the output diameter 116 of the output fiber 106. Additionally, the output fiber 106 may also be tapered up (e.g., up-tapering) from the end portion of the output diameter 116 of the output fiber 106 (Dᵢₙₚᵤₜ). In some implementations, a combination of the over-tapering of the input fibers 102 and the up-tapering of the output fiber 106 may enable the cladding light stripper 200 to remove light with a higher NA (e.g., NA higher than an NA threshold, provided herein) prior to entering the output fiber 106. In other words, the light removal section 202 may enable the cladding light stripper to remove high-NA cladding light 216 prior to entering the output fiber 106.

The cladding light stripper 200 illustrates over-tapering the down-tapered section 204 and up-tapering the output fiber 106. In one example, the cladding light stripper 200 may include 19 input fibers 102 (e.g., Nᵢₙₚᵤₜₛ=19), where the cladding diameter for each input fiber is 220 μm (e.g., Dᵢₙₚᵤₜ=220 μm), the output fiber 106 has a cladding diameter of 400 μm (e.g., Dₒᵤₜₚᵤₜ=400 μm), and the NA of the cladding of the output fiber 106 is 0.48. Rather than tapering the down-tapered section 204 down to the output diameter 116 of the output fiber 106 (e.g., as described in FIG. 1), the down-tapered section 204 is over-tapered down to a diameter of 180 μm. Accordingly, the TR between the effective diameter of the input fibers 102 and the tapered diameter is approximately

$$5.327 ( \sqrt{19} ( \frac{220}{180} ) \approx 5.327 ) .$$

Additionally, light with an NA of 0.22 in the input fibers 102 prior to tapering may have an NA of 1.17 after tapering down to the over-tapered diameter (0.22*TR=1.17). Additionally, the outer cladding of the light removal section 202 may be air, such that the outer cladding NA of the light removal section 202 is approximately 1.05. Because 1.17>1.05, the light with an NA of 0.22 prior to tapering can escape the input bundle after tapering (e.g., the light will not reach the output fiber 106). In other words, high-NA cladding light 216 may escape from the cladding light stripper 200 prior to entering the output fiber 106. Additionally, as shown in FIG. 2, the output fiber 106 is tapered up from the over-tapered diameter of 180 μm to the output diameter 116 of 400 μm. After up-tapering, the highest NA of light that enters the output fiber 106 may be equal to the outer cladding NA of the light removal section 202 multiplied by the ratio between the tapered diameter at the junction 214 and the output diameter

$$116 ( e . g . , 1.05 * ( \frac{180}{400} ) = 0.47 ) .$$

Because the highest possible NA value for light that enters the output fiber 106 is less than the NA of the cladding of the output fiber 106 (e.g., 0.47<0.48), no light that enters the output fiber 106 will be able to permeate through the outer cladding layer 110b of the output fiber 106. Therefore, the values of the NA of the light removal section 202 (NA_{LMS}), the tapered diameter (D_{tapered}), and output diameter 116 (Dₒᵤₜₚᵤₜ) may be configured such that the highest NA of light that enters the output fiber 106 is less than the NA of the outer cladding layer 110b of the output fiber 106 (NAₒᵤₜₚᵤₜ), in accordance with Equation 4:

$${NA}_{LMS} ( \frac{{D}_{tapered}}{{D}_{output}} ) < {NA}_{output} \qquad ( 4 )$$

In accordance with Equation 4, the smaller the ratio is between D_{tapered} and Dₒᵤₜₚᵤₜ, the lower the permissible output NA will be for light that enters the output fiber 106 (assuming there are no degradations in the tapering process). Therefore an up-taper ratio (TRᵤₚ) of the up-tapered section 206

$$( e . g . , where {TR}_{up} = \frac{{D}_{output}}{{D}_{tapered}} )$$

and the NA of the light removal section 202 (NA_{LMS}) define an NA threshold (e.g., NA_{Thresh}) for a permissible level of cladding light that can propagate through the output fiber 106. For example, the value of NA threshold (NA_{Thresh}) is defined in accordance with Equation 5:

$${NA}_{Thresh} = \frac{{NA}_{LMS}}{{TR}_{up}} = {NA}_{LMS} ( \frac{{D}_{tapered}}{{D}_{output}} ) \qquad ( 5 )$$

In other words, Equation 5 defines that an NA threshold is equal to the NA of the light removal section 202 divided by the up-taper ratio, where the up-taper ratio is equal to the output diameter 116 divided by the tapered diameter. In accordance with Equation 4 and Equation 5, the NA threshold is configured to be less than the NA of the outer cladding layer 110b of the output fiber 106 (NAₒᵤₜₚᵤₜ) (e.g., NA_{Thresh}<NAₒᵤₜₚᵤₜ). Additionally, one or more input fibers 102 are configured to propagate the cladding light to the output fiber 106. For example, the cladding light has an NA distribution, where a portion of the cladding light is associated with NAs that are greater than the NA threshold after moving through the down-tapered section 204 (e.g., the high-NA cladding light 216). Accordingly, the light removal section 202 is configured to remove the portion of the cladding light that is associated with NAs that are greater than the NA threshold.

In some implementations, the down-tapered section 204 and the up-tapered section 206 are enclosed by a glass material which is surrounded by air, and the NA of the light removal section 202 may be based on a refractive index of the glass material and a refractive index of the air. For example, the portion of the input fibers 102 that span the down-tapered section 204 and the portion of the output fiber 106 that span the up-tapered section 206 may be stripped of any cladding layers such that the cores 108 of the input fibers 102 and the output fiber 106 are in direct contact with the surrounding air. In other words, the air serves as the outer cladding layer for the one or more input fibers 102 and the output fiber 106, such that in light removal section 202 the cores 108 of the input fibers 102 and the output fiber 106 (e.g., a glass material) are surrounded by air (e.g., the outer cladding). Accordingly, the NA of the light removal section 202 (NA_{LMS}) may be based on the refractive index of the glass material of the cores 108 (e.g., n_{glass}) and the refractive index of the air (e.g., nₐᵢᵣ) in accordance with Equation 6:

NA_{LMS}=(n_{glass})²−(nₐᵢᵣ)² (6)

For instance, in accordance with Equation 6, if the refractive index of the cores 108 is 1.45 and the refractive index of the surrounding air is 1, then the NA of the light removal section 202 (NA_{LMS}) is approximately 1.05, as used above. The outer cladding layer of the light removal section 202 may be air, such that the high-NA cladding light 216 that escapes from the light removal section 202 does not burn through any coating material.

As described herein, the TR of the down-tapered section 204 and/or the up-tapered section 206 can be configured to remove light with an NA above a configured NA threshold. In some examples, the TR of the down-tapered section 204 and/or the up-tapered section 206 may be based on a permissible level of NA for light coming from the input fibers 102 (NA_{inputlight}), and the NA of the light removal section 202 (NA_{LMS}), in accordance with Equation 7:

$$TR = ( \frac{{NA}_{LMS}}{{NA}_{inputlight}} )$$

For instance, if the cladding light stripper 200 is configured to remove light from the input fibers 102 with an NA that is higher than 0.21 (e.g., NA_{inputlight}=0.21) and the outer cladding NA of the NA of the light removal section 202 is 1.05 (e.g., NA_{LMS}=1.05), then the TR is equal to 5

$$( TR = \frac{1.05}{0.21} = 5 ) .$$

Accordingly, any light from the input fibers 102 that has an NA that is higher than 0.21, after tapering, will be greater than 1.05, thus escaping from the cladding light stripper 200 (e.g., as part of the high-NA cladding light 216). Similarly, if the cladding light stripper 200 is configured to remove light from the input fiber 102 (or input fiber bundle including multiple input fibers 102) that is higher than 0.15 (e.g., NA_{inputlight}=0.15) and the NA of the light removal section 202 is 1.05 (e.g., NA_{LMS}=1.05), then the TR is equal to

$$( e . g . , TR = \frac{1.05}{0.21} = 7 ) .$$

Accordingly, any light from the input fiber 102 that is higher than 0.15, after tapering will be greater than 1.05, thus escaping from the cladding light stripper 200 (e.g., as part of the high-NA cladding light 216).

As shown in FIG. 2, the cladding light stripper further includes a light blocker 212. The light blocker 212 may be positioned around a portion of the up-tapered section 206, and the light blocker 212 may be configured to block a portion of the cladding light, that escapes from the light removal section 202 (e.g., the high-NA cladding light 216), from entering the output fiber 106. The light blocker 212 can be fabricated from materials that are effective at absorbing optical energy, thereby preventing the high-NA cladding light 216 from propagating further into the fiber system. Suitable materials for the light blocker 212 include metals such as stainless steel, copper, aluminum, and/or metal alloys engineered for high thermal conductivity and optical absorption (e.g., materials with a thermal conductivity coefficient that satisfies a thermal conductivity coefficient threshold and/or materials with an optical absorption coefficient that satisfies an optical absorption coefficient threshold). In some implementations, the light blocker 212 may comprise ceramics, composites, or engineered polymers that are treated or coated with light-absorbing substances, such as blackened or anodized surfaces, to enhance their absorption properties and minimize reflections.

While the light blocker 212 is depicted as having a ring shape in FIG. 2, the shape of the light blocker 212 is not limited to this geometry. The light blocker 212 may take on a variety of shapes and configurations (such as a sleeve, a partial shell, a patch, or a segmented structure) so long as the light blocker 212 effectively intercepts and absorbs the high-NA cladding light 216 that escapes from the light removal section 202. The design of the light blocker 212 can be tailored based on the specific distribution and propagation paths of the cladding light, as well as the mechanical and thermal characteristics of the fiber assembly.

As shown in FIG. 2, the down-tapered section 204 has a first length 208 and the up-tapered section 206 has a second length 210. The lengths of these tapered sections, and the resulting taper slope, can be optimized to control how and where high-NA cladding light 216 is dissipated. For example, by extending the first length 208 and/or the second length 210, the high-NA cladding light 216 may be gradually stripped from the cladding light stripper 200 and absorbed over a longer distance, which helps to distribute the resulting heat more evenly and reduces the risk of localized overheating or thermal damage to the cladding light stripper 200 and/or surrounding components. Specifically, the first length 208 and the second length 210 may be defined such that the temperature of the light removal section 202 (e.g., caused by the absorption of a portion of the cladding light that escapes from this region) satisfies a predetermined temperature threshold. This threshold may be established to ensure safe operation and to protect the integrity of the fiber assembly, preventing issues such as fiber burns, coating degradation, and/or failure of the light-blocking material. By optimizing both the taper slope and the overall dimensions of the tapered sections, the cladding light stripper 200 can efficiently manage the thermal load associated with high-power cladding light, enhancing both the performance and reliability of the optical fiber system.

FIG. 2 is provided as an example. Other examples may differ from what is described with regard to FIG. 2.

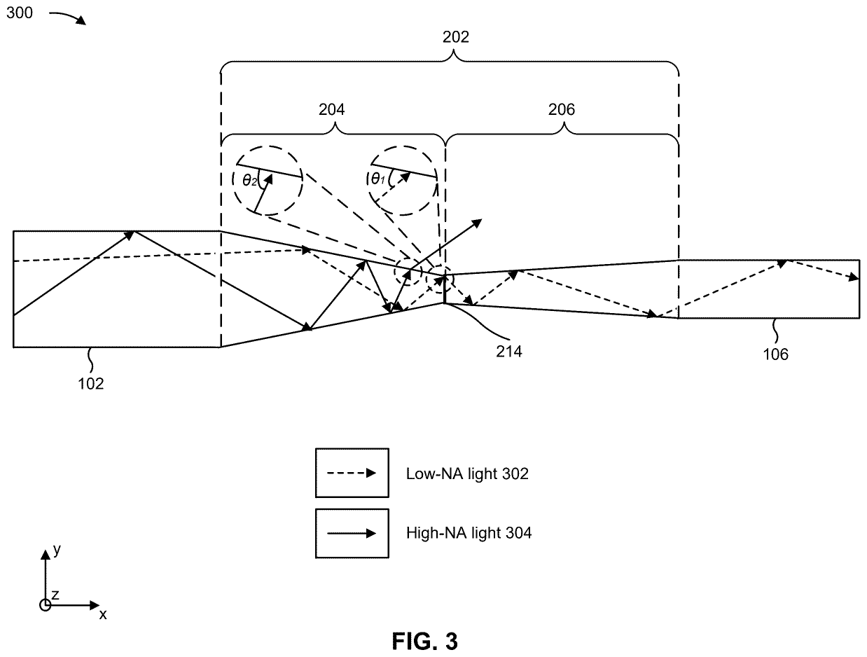

FIG. 3 shows light stripping 300 at a cladding light stripper according to one or implementations. As shown in FIG. 3, the light stripping 300 may be implemented at and/or performed by the cladding light stripper 200.

FIG. 3 illustrates how low-NA light 302 may continue the output fiber 106 after the light removal section 202 while high-NA light 304 escapes in the down-tapered section 204. In some examples, the low-NA light 302 may be light with an NA less than or equal to the NA threshold (NA_{threshold}) when passing through the junction 214. For example, as shown in FIG. 3, the low-NA light 302 may have an angle relative to the sidewall of the down-tapered section 204 of θ₁, where the value of θ₁ corresponds to an NA that is less than or equal to the NA_{threshold}. Accordingly, the low-NA light 302 may stay within the core of the light removal section 202 and continue traversing to the output fiber 106.

Conversely, the high-NA light 304 may be light with an NA greater than the NA threshold (NA_{threshold}) when traversing through the down-tapered section 204. For example, as shown in FIG. 3, at the point in which the high-NA light 304 passes through the sidewall of the down-tapered section 204, the high-NA light 304 has an angle relative to the sidewall of θ₂, where the value of θ₂ corresponds to an NA that is greater to the NA_{threshold}. Accordingly, the high-NA light 304 may permeate outside of the core of the light removal section 202, and therefore may not enter the output fiber 106.

FIG. 3 is provided as an example. Other examples may differ from what is described with regard to FIG. 3.

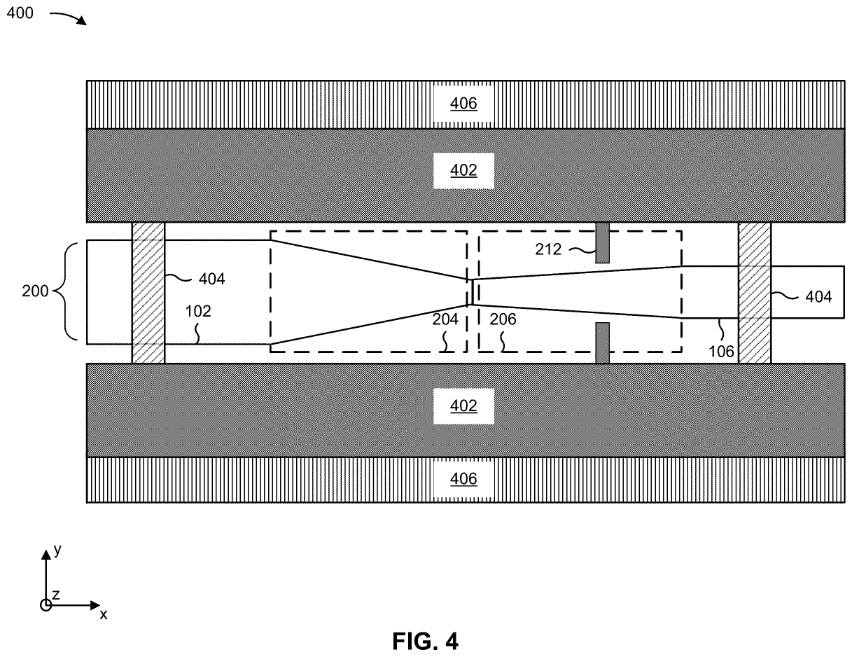

FIG. 4 shows a cross-sectional view 400 of a housing 402 that encloses a cladding light stripper according to one or implementations. As shown in FIG. 3, the housing 402 may enclose the cladding light stripper 200.

The housing 402 is provided to enclose the cladding light stripper 200 and may be designed to absorb heat generated by cladding light that escapes from the light removal section 202 (e.g., the high-NA cladding light 216). This housing 402 may serve as a thermal sink, efficiently dissipating the heat to maintain the stability and longevity of the input fibers 102 and output fiber 106. The housing 402 may be constructed from materials with high thermal conductivity (e.g., a thermal conductivity that satisfies a thermal conductivity threshold), such as metals like aluminum or copper, and/or metal alloys like stainless steel, to absorb and spread heat. Additionally, or alternatively, the housing 402 may be made from other heat-absorbing materials such as graphite composites, ceramics, and/or thermally conductive polymers, depending on the specific application of the cladding light stripper 200. Accordingly, the housing 402 can manage the heat produced by the absorbed cladding light, ensuring reliable operation and protecting sensitive fiber components.

The housing 402 may be designed to circumferentially enclose the cladding light stripper 200 along a longitudinal axis of the cladding light stripper 200, which aligns with the x-axis of the cladding light stripper 200. In other words, the housing 402 may surround the cladding light stripper 200 from all sides, providing a protective and heat-absorbing barrier around the full or partial length of the cladding light stripper 200. The housing 402 can take the form of any three-dimensional prism (such as a rectangular or cylindrical structure) depending on the specific design parameters and/or space constraints. Additionally, the housing 402 features a through hole that runs parallel to the longitudinal axis and is sized sufficiently wide to accommodate the cladding light stripper 200, ensuring enclosure of the cladding light stripper 200 without impeding function. This geometric configuration allows the housing 402 to both protect the cladding light stripper 200 and efficiently absorb heat from any escaping cladding light, while also allowing for integration into larger optical assemblies.

Within the housing 402, the input fibers 102 and output fiber 106 can be securely fixed in place (e.g., using an anchoring material 404, such as glue or another suitable adhesive material). By anchoring these fibers at designated points within the housing 402, the light removal section 202 of the cladding light stripper 200 may be effectively suspended in air, rather than coming into direct contact with an inner surface of the housing 402. This suspended configuration may be advantageous, as suspending the light removal section 202 allows cladding light to efficiently permeate from the cladding light stripper 200 into the surrounding air within the housing 402. The air gap around the light removal section 202, therefore, reduces reflections and enhances the efficiency of cladding light removal, while the fixed positioning of the fibers ensures mechanical stability.

A cooling component 406 can be attached to the exterior of the housing 402 to ensure effective thermal management by maintaining the temperature of the housing 402 that satisfies specified temperature threshold. This cooling component 406 may take various forms depending on the cooling requirements and the operating environment. For instance, a passive heat sink made of finned aluminum or copper can be mounted to the housing 402 to increase surface area and promote natural air convection for dissipating heat. Additionally, or alternatively, an active cooling solution such as a thermoelectric cooler (TEC) can be integrated to provide precise temperature control by actively transferring heat away from the housing 402. Additionally, or alternatively, a liquid cooling jacket or coil can be wrapped around the housing 402, circulating coolant through a closed-loop system to absorb and remove heat efficiently. Other examples include attaching a forced air fan to direct airflow over the housing 402 or embedding phase change materials that absorb excess heat as the materials melt. By selecting the appropriate cooling component 406, the system can reliably keep the housing 402 within the desired temperature range, protecting the optical fiber assembly and ensuring consistent performance.

FIG. 4 is provided as an example. Other examples may differ from what is described with regard to FIG. 4.

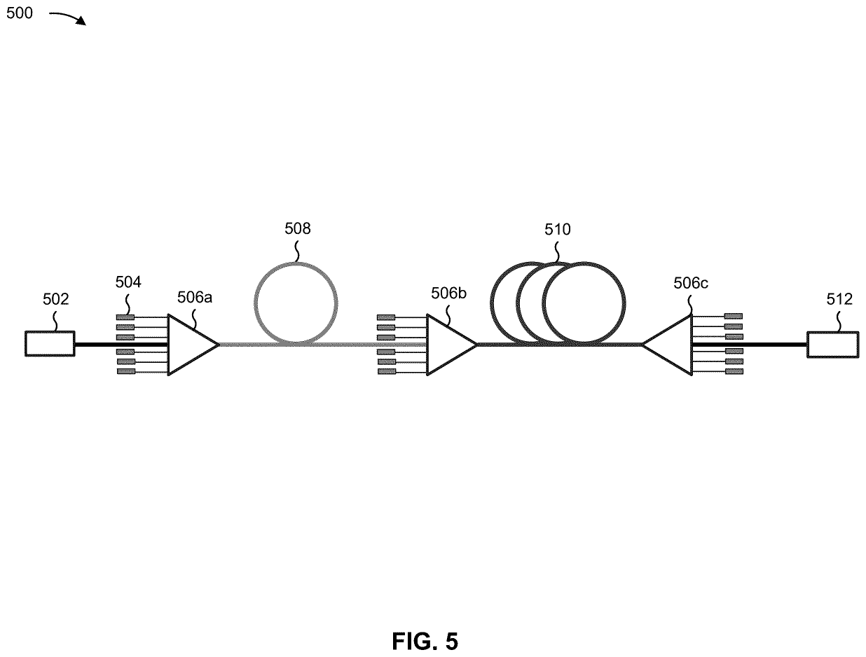

FIG. 5 illustrates an example laser system 500 according to one or more implementations. In some examples, the laser system 500 may implement the cladding light stripper 200. In some examples, the laser system 500 may include or be an example of one or more high-power cladding pumped fiber lasers (e.g., fiber lasers that reach a power greater than or equal to 100 KW). To achieve the high power output, multiple laser diodes 504 may be combined as input to a single output fiber.

The laser system 500 may be configured to deliver optical power of an input signal 502 with high efficiency and precision. Central to this system may be multiple laser diodes 504, which serve as the primary pump sources. These diodes 504 emit light at specific wavelengths and are chosen for high output power and efficiency. As shown in FIG. 5, the emitted light from these diodes 504 may be directed into a pump signal combiner (PSC) 506a for forward pumping. This PSC 506a may be a component that combines the optical power from multiple laser diodes 504 into a single fiber, ensuring that the maximum amount of pump light is delivered into the laser system 500.

Following the forward pumping stage, the laser system 500 may include an oscillator 508, which may be responsible for generating the initial laser signal. The oscillator may comprise a doped fiber (such as ytterbium-doped fiber), which provides the gain medium that enables lasing. The oscillator establishes the fundamental laser beam characteristics, such as wavelength and coherence, which are then amplified in subsequent stages.

The laser signal may then be subjected to cascaded pumping through a PSC 506b. This stage involves additional pump diodes 504 that further increase the power of the laser signal by injecting more pump light into the laser system 500. The cascaded pumping technique enhances the efficiency and output power of the laser system 500 by utilizing multiple stages of amplification.

An amplifier 510 follows the cascaded pumping stage, where the laser signal undergoes power amplification. The amplifier 510 may include a length of doped fiber that provides additional gain to the laser signal, boosting a power of the laser signal to a configured level.

To further enhance the efficiency and output power, the laser system 500 may employ a PSC for backward pumping. In this configuration, additional pump light may be introduced via a PSC 506c in the opposite direction to the laser signal, providing further amplification and enabling uniform gain distribution along the fiber. This backward pumping technique helps in achieving higher output powers and improved beam quality.

After backward pumping, the amplified laser signal exits the laser system 500 as a laser output 512. This output may be characterized by high power, beam quality, and stability. The combination of forward and backward pumping, along with cascaded amplification, ensures that the laser system 500 operates at peak efficiency and delivers optimal performance.

In some implementations, one or more portions of the laser system 500 may increase the NA of the light (such as during forward pumping, cascaded pumping, and/or backward pumping). Accordingly, the laser system 500 may include one or more cladding light strippers (e.g., the cladding light stripper 200) at one or more portions of the laser system 500 to reduce the NA of light that exits through to the laser output. Therefore, the inclusion of the one or more cladding light strippers may effectively remove light with an NA above an NA threshold configured by the cladding light strippers, reducing the likelihood of light that permeates through the cladding layers of downstream optical fibers.

FIG. 5 is provided as an example. Other examples may differ from what is described with regard to FIG. 5.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A cladding light stripper, comprising:
one or more input fibers that have an effective input diameter;
an output fiber that has an output diameter; and
a light removal section, wherein the light removal section comprises:
a down-tapered section that tapers the one or more input fibers from the effective input diameter down to a tapered diameter; and
an up-tapered section, connected to the down-tapered section, that tapers the output fiber from the tapered diameter up to the output diameter, wherein an up-taper ratio of the up-tapered section and a numerical aperture (NA) of the light removal section define an NA threshold for cladding light that can propagate through the output fiber.

2. The cladding light stripper of claim 1, wherein the one or more input fibers are configured to propagate the cladding light to the output fiber, and wherein:
the cladding light has an NA distribution,
a portion of the cladding light is associated with NAs that are greater than the NA threshold, and
the light removal section is configured to remove the portion of the cladding light that is associated with NAs that are greater than the NA threshold.

3. The cladding light stripper of claim 1, wherein the output fiber comprises an outer cladding layer, and wherein the NA threshold is less than an NA of the outer cladding layer.

4. The cladding light stripper of claim 1, wherein the down-tapered section and the up-tapered section are enclosed by a glass material which is surrounded by air, and wherein the NA of the light removal section is based on a refractive index of the glass material and a refractive index of the air.

5. The cladding light stripper of claim 1, wherein the up-taper ratio is equal to the output diameter divided by the tapered diameter, and wherein the NA threshold is equal to the NA of the light removal section divided by the up-taper ratio.

6. The cladding light stripper of claim 1, wherein the light removal section includes a junction at which an end of the down-tapered section connects to a start of the up-tapered section, and wherein the one or more input fibers are spliced to the output fiber at the junction.

7. The cladding light stripper of claim 1, further comprising:
a light blocker positioned around a portion of the up-tapered section, wherein the light blocker is configured to block a portion of the cladding light, that escapes from the light removal section, from entering the output fiber.

8. The cladding light stripper of claim 1, wherein a metal housing encloses the cladding light stripper and is configured to absorb heat from a portion of the cladding light that escapes from the light removal section.

9. The cladding light stripper of claim 8, wherein a cooling component is attached to the metal housing, and wherein the cooling component is configured to maintain a temperature of the metal housing to satisfy a temperature threshold.

10. The cladding light stripper of claim 1, wherein a length of the down-tapered section and a length of the up-tapered section are defined such that a temperature of the light removal section, caused by a portion of the cladding light that escapes from the light removal section, satisfies a temperature threshold.

11. The cladding light stripper of claim 1, wherein the tapered diameter is less than the output diameter and the output diameter is less than or equal to the effective input diameter.

12. A cladding light stripper, comprising:
an input fiber that has an input diameter;
an output fiber that has an output diameter; and
a light removal section, wherein the light removal section comprises:
a down-tapered section that tapers the input fiber from the input diameter down to a tapered diameter; and
an up-tapered section, connected to the down-tapered section, that tapers the output fiber from the tapered diameter up to the output diameter, wherein an up-taper ratio of the up-tapered section and a numerical aperture (NA) of the light removal section define an NA threshold for cladding light that can propagate through the output fiber.

13. The cladding light stripper of claim 12, wherein the input fiber is configured to propagate the cladding light to the output fiber, and wherein:
the cladding light has an NA distribution,
a portion of the cladding light is associated with NAs that are greater than the NA threshold, and
the light removal section is configured to remove the portion of the cladding light that is associated with the NAs that are greater than the NA threshold.

14. The cladding light stripper of claim 12, wherein the output fiber comprises an outer cladding layer, and wherein the NA threshold is less than an NA of the outer cladding layer.

15. The cladding light stripper of claim 12, wherein the down-tapered section and the up-tapered section are enclosed by a glass material which is surrounded by air, and wherein the NA of the light removal section is based on a refractive index of the glass material and a refractive index of the air.

16. The cladding light stripper of claim 12, wherein the up-taper ratio is equal to the output diameter divided by the tapered diameter, and wherein the NA threshold is equal to the NA of the light removal section divided by the up-taper ratio.

17. The cladding light stripper of claim 12, wherein the light removal section includes a junction at which an end of the down-tapered section connects to a start of the up-tapered section, and wherein the input fiber is spliced to the output fiber at the junction.

18. The cladding light stripper of claim 12, further comprising:
a light blocker positioned around a portion of the up-tapered section, wherein the light blocker is configured to block a portion of the cladding light, that escapes from the light removal section, from entering the output fiber.

19. The cladding light stripper of claim 12, wherein a metal housing encloses the cladding light stripper and is configured to absorb heat from a portion of the cladding light that escapes from the light removal section.

20. An optical fiber system incorporating a cladding light stripper, comprising:
a plurality of input fibers that have an effective input diameter;
an output fiber that has an output diameter;
a light removal section that comprises a down-tapered section that tapers the plurality of input fibers from the effective input diameter down to a tapered diameter and an up-tapered section, connected to the down-tapered section, that tapers the output fiber from the tapered diameter up to the output diameter, wherein an up-taper ratio of the up-tapered section and a numerical aperture (NA) of the light removal section define an NA threshold for cladding light that can propagate through the output fiber;
a light blocker positioned around a portion of the up-tapered section that is configured to block a portion of the cladding light, that escapes from the light removal section, from entering the output fiber; and
a metal housing that encloses the cladding light stripper and is configured to absorb heat from the portion of the cladding light that escapes from the light removal section.
